(19) United States
(12) Patent Application Publication
(10) Pub. No.: US 2009/0034449 A1
(43) Pub. Date: Feb. 5, 2009

(54) FINGER MANAGER FOR ENHANCED DEDICATED CHANNEL (E-DCH) APPLICATIONS

(75) Inventors: Hongwei Kong, Denville, NJ (US); John (Qiang) Zhang, San Diego, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 11/963,798

(22) Filed: Dec. 22, 2007

Related U.S. Application Data
(60) Provisional application No. 60/953,460, filed on Aug. 1, 2007.

(51) Int. Cl. H04B 7/216

(52) U.S. Cl. 370/320

(57) ABSTRACT

A downlink channel receiver operable to implement finger management strategies with fractional dedicated physical channel (F-DPCH) and E-DCH processing within a Rake receiver structure is provided. The downlink channel receiver includes a receiver, a baseband processing block, and a WCDMA processing block, wherein F-DPCH and E-DCH processing is divided between a plurality of hardware processing blocks and a plurality of firmware (FW) processing blocks. The finger management strategies within the Rake receiver structure are implemented by the plurality of FW processing blocks.

### CROSS REFERENCE TO RELATED APPLICATIONS

The present U.S. Utility Patent Application claims priority pursuant to 35 U.S.C. §119(e) to the following U.S. Provisional Patent Applications which are hereby incorporated herein by reference in their entirety and made part of the present U. S. Utility Patent Application for all purposes:

1. U.S. Provisional Application Ser. No. 60/953,460, entitled “FINGER MANAGER FOR ENHANCED DEDICATED CHANNEL (E-DCH) APPLICATIONS,”(Attorney Docket No. BP6323) filed Aug. 1, 2007, pending.

### TECHNICAL FIELD OF THE INVENTION

The present invention relates generally to cellular wireless communication systems, and more particularly to the finger management of a Rake receiver within a wireless terminal of a cellular wireless communication system that supports high speed data packet access (HSDPA).

### BACKGROUND OF THE INVENTION

Cellular wireless communication systems support wireless communication services in many populated areas of the world. While cellular wireless communication systems were initially constructed to service voice communications, they are now called upon to support data and video (multimedia) communications as well. The demand for video and data communication services has exploded with the acceptance and widespread use video capable wireless terminals and the Internet. Video and data communications have historically been serviced via wired connections; cellular wireless users now demand that their wireless units also support video and data communications. The demand for wireless communication system video and data communications will only increase with time. Thus, cellular wireless communication systems are currently being created/modified to service these burgeoning demands.

Cellular wireless networks include a “network infrastructure” that wirelessly communicates with wireless terminals within a respective service coverage area. The network infrastructure typically includes a plurality of base stations dispersed throughout the service coverage area, each of which supports wireless communications within a respective cell (or set of sectors). The base stations couple to controllers, with each controller serving a plurality of Node B's. Each controller couples to a mobile switching center (MSC). Each controller also typically directly or indirectly couples to the Internet. In the 3^{rd} Generation Partnership Agreement (3GPP) these base stations may be referred to as “Node B's” and the wireless terminals may be referred to as user equipment (UE).

In operation, each Node B communicates with a plurality of wireless UEs operating in its cell/sectors. A controller coupled to the Node B routes voice, video, data or multimedia communications between the MSC and a serving base station. The MSC then routes these communications to another MSC or to the PSTN. Typically, controllers route data communications between a servicing Node B and a packet data network that may include or couple to the Internet. Transmissions from base stations to wireless terminals are referred to as “forward link” or “downlink” transmissions while transmissions from wireless terminals to base stations are referred to as “reverse link” or “uplink” transmissions. The volume of data transmitted on the forward link typically exceeds the volume of data transmitted on the reverse link. Such is the case because data users typically issue commands to request data from data sources, e.g., web servers, and the web servers provide the data to the wireless terminals. The great number of wireless terminals communicating with a single Node B forces the need to divide the forward and reverse link transmission resources (depending on the specific wireless standards, the resources could be frequency band, time slot, orthogonal code, and transmit power) amongst the various wireless terminals.

Wireless links between base stations and their serviced wireless terminals typically operate according to one (or more) of a plurality of operating standards. These operating standards define the manner in which the wireless link may be allocated, setup, serviced and torn down. One popular cellular standard is the Global System for Mobile telecommunications (GSM) standard. The GSM standard, or simply GSM, is predominant in Europe and is in use around the globe. The GSM standard has evolved in part into the 3^{rd} Generation Partnership Agreement (3GPP). 3GPP provides Technical Specifications and Technical Reports for a 3rd Generation Mobile System based on evolved GSM core networks and the radio access technologies that they support (i.e., UMTS Terrestrial Radio Access (UTRA) both Frequency Division Duplex (FDD) and Time Division Duplex (TDD) modes). The scope also includes the maintenance and development of the Global System for Mobile communication (GSM) Technical Specifications and Technical Reports including evolved radio access technologies (e.g. General Packet Radio Service (GPRS) and Enhanced Data rates for GSM Evolution (EDGE)). While GSM originally serviced only voice communications, it has been modified to also service data communications. General Packet Radio Service (GPRS) operations and the Enhanced Data rates for GSM (or Global) Evolution (EDGE) operations coexist with GSM by sharing the channel bandwidth, slot structure, and slot timing of the GSM standard. GPRS operations and EDGE operations may also serve as migration paths for other standards as well, e.g., IS-136 and Pacific Digital Cellular (PDC).

Third generation (3G) cellular networks have been specifically designed to fulfill the future demands of the mobile Internet. As mobile Internet services grow in popularity and usage, factors such as cost efficient optimization of network capacity and quality of service (QoS) will become ever more essential to cellular operators. These factors may be achieved with careful network planning and operation, improvements in transmission methods, and advances in receiver techniques. To this end, carriers need technologies that will allow them to increase uplink and downlink throughput and, in turn, offer advanced QoS capabilities and speeds that rival those delivered by cable modem and/or DSL service providers. In this regard, networks based on wideband CDMA (WCDMA) technology can make the delivery of data to end users a more feasible option for today's wireless carriers. WCDMA has evolved continuously towards higher data rates and towards packet-switched IP-based services.

GPRS and EDGE technologies may be utilized for enhancing the data throughput of present second generation (2G) systems such as GSM. The GSM technology may support data rates of up to 14.4 kilobits per second (Kbps), while the GPRS technology may support data rates of up to 115 Kbps by allowing up to 8 data time slots per time division multiple access (TDMA) frame. The EDGE technology, a further enhancement to GPRS, may support data rates of up to 384 Kbps. The EDGE technology may utilizes 8 phase shift keying (8-PSK) modulation to provide higher data rates than those that may be achieved by GPRS technology. The GPRS and EDGE technologies may be referred to as “2.5 G” technologies.

UMTS technology with theoretical data rates as high as 2 Mbps, is a 3G evolution of GSM, using wideband CDMA technology. UMTS may achieve higher data rates than GSM/EDGE due to many enhancements, including higher transmission bandwidth, adaptive higher order modulation and interference averaging due to a unity frequency reuse factor.

High-Speed Downlink Packet Access (HSDPA) technology is an Internet protocol (IP) based service, oriented towards data communications, which adapts WCDMA to support data transfer rates in the order of 14 megabits per second (Mbit/s). Developed by the 3G Partnership Project (3GPP) group, the HSDPA technology achieves higher data rates through a plurality of methods. In order to avoid excessive interference, 3G WCDMA may require fast power control to maintain a constant error rate. The HSDPA technology changes this paradigm and, in addition to adapting transmission power, also changes the coding and modulation rate to adapt to changing channel conditions. Other methods that may be used to improve the data throughput are fast packet scheduling and a fast retransmission of lost packets by using Hybrid Automatic repeat ReQuest (H-ARQ) techniques. HSDPA does not support soft handover, so at anytime, there is one HSDPA serving cell that communicates with the UE using HSDPA protocol.

In 3GPP release 6, high speed uplink packet access (HSUPA) is further introduced. Similar to HSDPA, it employs H-ARQ on the uplink to increase the data rate and reduce access time. Contrary to HSDPA, HSUPA supports soft handover in the sense that multiple Node Bs or cells can be configured to receive the data from the same UE's HSUPA transmission. Therefore all the NodeBs involved in the HSUPA links can send control information in the downlink to the UE. However, since the downlink data communication is mainly done on the HSDPA/HSUPA serving cell, the strategy for receiving and responding to the HSUPA channels in the downlink need to be different from that for the legacy WCDMA channels.

### BRIEF SUMMARY OF THE INVENTION

Embodiments of the present invention are directed to systems and methods that are further described in the following description and claims. Advantages and features of embodiments of the present invention may become apparent from the description, accompanying drawings and claims.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 is a system diagram illustrating a portion of a cellular wireless communication system that supports wireless terminals operating according to the practice of the present invention;

FIG. 2 is a block diagram functionally illustrating a wireless terminal or UE constructed according to embodiments of the present invention;

FIG. 3 is a block diagram illustrating in more detail the wireless terminal of FIG. 2, with particular emphasis on the baseband processing components of the wireless terminal;

FIG. 4 shows a diagram of a radio link between a User Equipment (UE) and Node B 402 in accordance with embodiments of the present invention;

FIG. 5 provides a diagram of a top-level block diagram of such a WCDMA receiver in accordance with embodiments of the present invention;

FIG. 6 provides the data/control path between major processing functions inside the F-DPCH processing block in accordance with embodiments of the present invention;

### DETAILED DESCRIPTION OF THE DRAWINGS

Preferred embodiments of the present invention are illustrated in the FIGS., like numerals being used to refer to like and corresponding parts of the various drawings.

Embodiments of the present invention provide a downlink channel receiver operable to implement finger management strategies with fractional dedicated physical channel (F-DPCH) processing within a Rake receiver structure. The downlink channel receiver includes a receiver, a baseband processing block, and a WCDMA processing block, wherein F-DPCH processing is divided between a plurality of hardware processing blocks and a plurality of firmware (FW) processing blocks. The receiver is operable to convert a radio frequency (RF) signal to a baseband signal. The baseband processing block operable to processes and provides the baseband signal to the WCDMA processing block. F-DPCH processing is divided between the plurality of hardware processing blocks and plurality of firmware (FW) processing blocks. The finger management strategies within the Rake receiver structure are implemented by the plurality of FW processing blocks.

The embodiments of the present invention may be practiced in a variety of settings that utilize a wireless communication receiver. The specific embodiments described below pertain to communication channels associated with a 3^{rd} Generation Partnership Project (3GPP) telecommunication technology and, in particular, HSDPA/HSUPA technology associated with WCDMA. However, the invention need not be limited to such applications and other embodiments of the invention may be implemented in other communications protocols and standards. Furthermore, the invention is not limited for use with WCDMA only and may be used in many other wireless technologies as well.

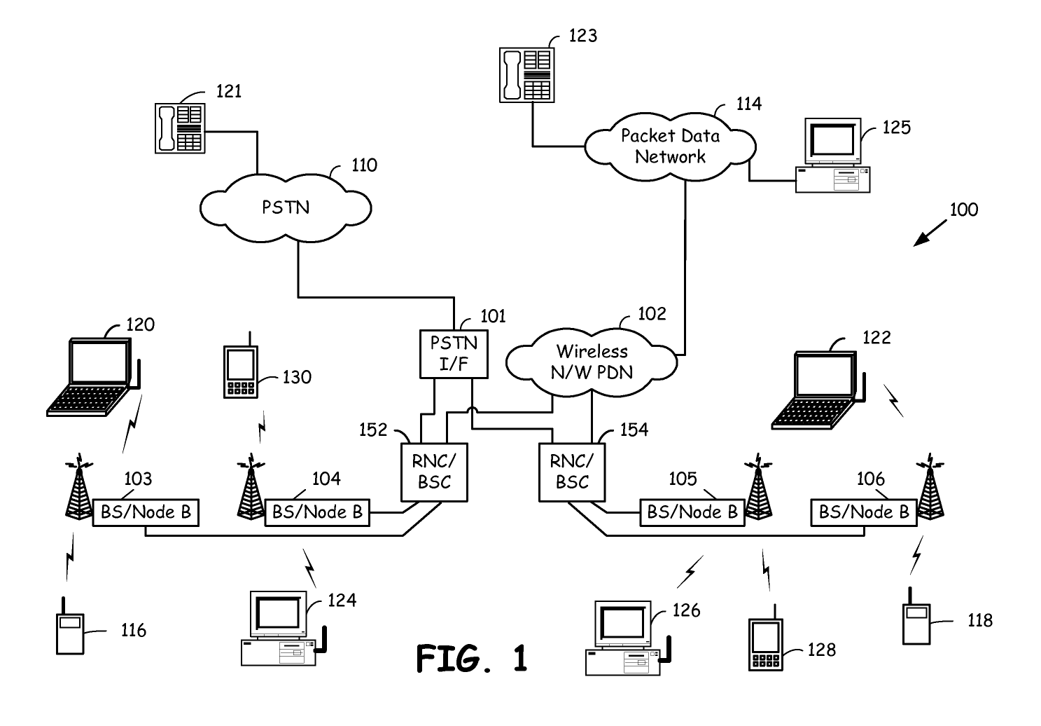

FIG. 1 is a system diagram illustrating a portion of a cellular wireless communication system 100 that supports wireless terminals operating according to the practice of the invention. The cellular wireless communication system 100 includes a Public Switched Telephone Network (PSTN) interface 101 (such as a Mobile Switching Center), a wireless Packet Data Network (PDN) 102 (that may include GPRS Support Nodes, EDGE Support Nodes, WCDMA Support Nodes, and other components), Radio Network Controllers/Base Station Controllers (RNC/BSCs) 152 and 154, and base stations (BSs) 103, 104, 105, and 106, each of which are also referred to as Node B. The wireless network PDN 102 may be coupled to private and public packet data network 114, such as the Internet, WANs, LANs, etc. A conventional voice terminal 121 couples to a PSTN 110. A Voice over Internet Protocol (VoIP) terminal 123 and a personal computer (PC) 125 are shown coupled to the network 114. The PSTN Interface 101 may couple to a PSTN 110. Of course, this particular structure may vary from system to system and the particular system 100 is shown as an example only.

Each of the BS/Node Bs 103-106 services a cell or set of sectors within which it supports wireless communications. Wireless links that include both downlink components and uplink components support wireless communications between the base stations and their serviced wireless terminals. These wireless links support digital data communications, VoIP communications, and other digital multimedia communications. The cellular wireless communication system 100 may also be backward compatible in supporting analog operations as well. Cellular wireless communication system 100 supports one or more of the UMTS/WCDMA standards, the Global System for Mobile telecommunications (GSM) standards, the GSM General Packet Radio Service (GPRS) extension to GSM, the Enhanced Data rates for GSM (or Global) Evolution (EDGE) standards, and/or various other CDMA standards, TDMA standards and/or FDMA standards, etc. System 100 may also support one or more versions or “Releases” of the 3^{rd} Generation Partnership Project (3GPP) telecommunication technology.

FIG. 1 also shows wireless terminals 116, 118, 120, 122, 124, 126, 128, and 130 coupled to cellular wireless communication system 100 via wireless links with base stations 103-106. As illustrated, wireless terminals may include cellular telephones 116 and 118, laptop computers 120 and 122, desktop computers 124 and 126, and data terminals 128 and 130. However, cellular wireless communication system 100 may support communications with other types of wireless terminals and devices as well. Devices such as laptop computers 120 and 122, desktop computers 124 and 126, data terminals 128 and 130, and cellular telephones 116 and 118, are typically enabled to “surf” the Internet, transmit and receive data communications such as email and text messaging, transmit and receive files, and to perform other data operations. Many of these data operations have significant download (downlink) data-rate requirements while the upload (uplink) data-rate requirements are not as severe. Some or all of wireless terminals 116-130 are therefore enabled to support the EDGE operating standard, the GPRS standard, the UMTS/WCDMA standards, the GSM standard and/or the 3GPP standard.

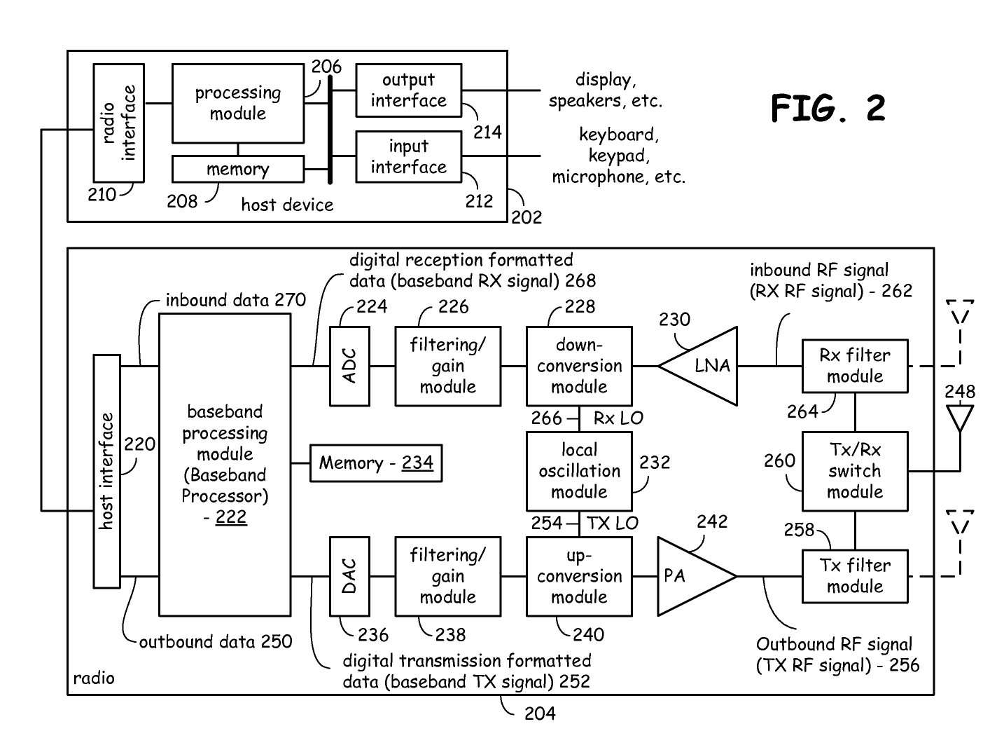

FIG. 2 is a schematic block diagram illustrating a wireless terminal that includes host processing components of a host device 202 and an associated radio 204. For cellular telephones, the host processing components of host device 202 and the radio are contained within a single housing. In some cellular telephones, the host processing components and some or all of the components of radio 204 are formed on a single Integrated Circuit (IC). For personal digital assistants hosts, laptop hosts, and/or personal computer hosts, radio 204 may reside within an expansion card and, therefore, reside separately from the host 202. The host processing components of host 202 may include a processing module 206, memory 208, radio interface 210, an input interface 212, and an output interface 214. Processing module 206 and memory 208 execute instructions to support host terminal functions. For example, for a cellular telephone host device, processing module 206 performs user interface operations and executes host software programs among other operations. Furthermore, as noted in FIG. 2, the host device may include or be coupled to one or more user interfaces (such as displays, speakers, headphones, keyboards, keypads, microphones, etc.).

Radio interface 210 allows data to be received from and sent to radio 204. For data received from radio 204 (e.g., inbound data), radio interface 210 provides the data to processing module 206 for further processing and/or routing to output interface 214. Output interface 214 provides connectivity to one or more output display devices. Radio interface 210 also provides data from processing module 206 to radio 204. Processing module 206 may receive the outbound data from one or more input device via input interface 212 or generate the data itself. For data received via input interface 212, the processing module 206 may perform a corresponding host function on the data and/or route it to radio 204 via radio interface 210.

Radio 204 includes a host interface 220, baseband (BB) processing module 222 (baseband processor) 222, analog-to-digital converter (ADC) 224, filtering/gain module 226, down conversion module 228, low noise amplifier (LNA) 230, local oscillation module 232, memory 234, digital-to-analog converter (DAC) 236, filtering/gain module 238, up-conversion module 240, power amplifier (PA) 242, RX filter module 264, TX filter module 258, TX/RX switch module 260, and antenna 248. Antenna 248 may be a single antenna that is shared by transmit and receive paths or may include separate antennas for the transmit path and the receive path. The antenna implementation may depend on the particular standard to which the wireless communication device is compliant.

Baseband processing module 222 in combination with operational instructions stored in memory 234, execute digital receiver functions and digital transmitter functions. The digital receiver functions include, but are not limited to, digital intermediate frequency to baseband conversion, demodulation, constellation demapping, descrambling, and/or decoding,. The digital transmitter functions include, but are not limited to, encoding, scrambling, constellation mapping, modulation, and/or digital baseband to IF conversion. The transmit and receive functions provided by baseband processing module 222 may be implemented using shared processing devices and/or individual processing devices. Processing devices may include microprocessors, micro-controllers, digital signal processors, microcomputers, central processing units, field programmable gate arrays, programmable logic devices, state machines, logic circuitry, analog circuitry, digital circuitry, and/or any device that manipulates signals (analog and/or digital) based on operational instructions. Memory 234 may be a single memory device or a plurality of memory devices. Such a memory device may be a read-only memory, random access memory, volatile memory, non-volatile memory, static memory, dynamic memory, flash memory, and/or any device that stores digital information. Note that when baseband processing module 222 implements one or more of its functions via a state machine, analog circuitry, digital circuitry, and/or logic circuitry, the memory storing the corresponding operational instructions may be embedded with the circuitry comprising the state machine, analog circuitry, digital circuitry, and/or logic circuitry.

In operation, radio 204 receives outbound data 250 from the host processing components via host interface 220. Host interface 220 routes outbound data 250 to baseband processing module 222, which processes outbound data 250 in accordance with a particular wireless communication standard (e.g., UMTS/WCDMA, GSM, GPRS, EDGE, 3GPP, et cetera) to produce digital transmission formatted data 252. Digital transmission formatted data 252 is a digital base-band signal or a digital low IF signal.

Digital-to-analog converter 236 converts digital transmission formatted data 252 from the digital domain to the analog domain. Filtering/gain module 238 filters and/or adjusts the gain of the analog signal prior to providing it to up-conversion module 240. Up-conversion module 240 directly converts the analog baseband or low IF signal into an RF signal based on a transmitter local oscillation signal (TX LO) 254 provided by local oscillation module 232. Power amplifier 242 amplifies the RF signal to produce outbound RF signal 256, which is filtered by TX filter module 258. TX/RX switch module 260 receives the amplified and filtered RF signal from TX filter module 258 and provides output RF signal 256 signal to antenna 248, which transmits outbound RF signal 256 to a targeted device, such as to one of base stations 103-106 of FIG. 1.

Radio 204 also receives an inbound RF signal 262, which was transmitted by a base station via antenna 248, TX/RX switch module 260, and RX filter module 264. Low noise amplifier 230 receives inbound RF signal 262 and amplifies inbound RF signal 262 to produce an amplified inbound RF signal. Low noise amplifier 230 provides the amplified inbound RF signal to down conversion module 228, which converts the amplified inbound RF signal into an inbound low IF signal or baseband signal based on a receiver local oscillation signal (RX LO) 266 provided by local oscillation module 232. Down conversion module 228 provides the inbound low IF signal (or baseband signal) to filtering/gain module 226, which filters and/or adjusts the gain of the signal before providing it to analog to digital converter 224.

Analog-to-digital converter 224 converts the filtered inbound low IF signal (or baseband signal) from the analog domain to the digital domain to produce digital reception formatted data 268. Baseband processing module 222 demodulates, demaps, descrambles, and/or decodes the digital reception formatted data 268 to capture inbound data 270 in accordance with the particular wireless communication standard being implemented by radio 204. Host interface 220 provides inbound data 270 to the host processing components of host device 202 via radio interface 210.

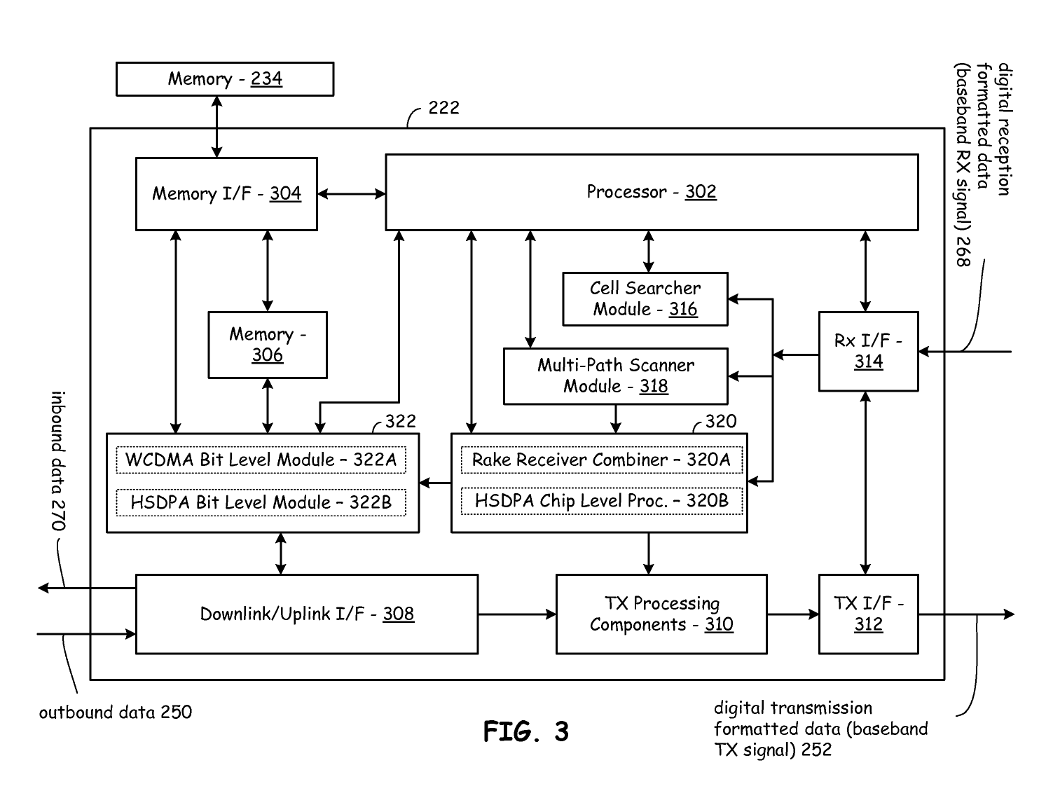

FIG. 3 is a block diagram illustrating one embodiment for baseband processing module 222 of FIG. 2. Components of baseband processing module (baseband processor) 222 include a processor 302, a memory interface 304, onboard memory 306, a downlink/uplink interface 308, TX processing components 310, and a TX interface 312. Baseband processing module 222 further includes an RX interface 314, a cell searcher module 316, a multi-path scanner module 318, a chip level processing module 320, and a bit level processing module 322.

Chip level processing module 320 includes a rake receiver combiner 320A that generally supports WCDMA receive processing operations and a HSDPA chip level processing module 320B that generally supports HSDPA receive processing operations. Bit level processing module 322 includes a WCDMA bit-level processing module 322A that supports WCDMA bit-level operations and a HSDPA bit-level processing module 322B that supports HSDPA bit-level operations.

In some embodiments, baseband processing module 222 couples to external memory 234. However, in other embodiments, memory 306 may fulfill the memory requirements of baseband processing module 302. According to some aspects of the present invention, memory 306 is cacheable while memory 234 is non-cacheable. Of course, in other embodiments, memory 234 may also be cacheable. As was previously described with reference to FIG. 2, baseband processing module 222 receives outbound data 250 from coupled host processing components 202 and provides inbound data 270 to the coupled host processing components 202. Further, baseband processing module 222 provides digital formatted transmission data (baseband TX signal) 252 to a coupled RF front end. Baseband processing module 222 receives digital reception formatted data (baseband RX signal) 268 from the coupled RF front end. As was previously described with reference to FIG. 2, an ADC 222 produces the digital reception formatted data (baseband RX data) 268 while DAC 236 of the RF front end receives the digital transmission formatted data (baseband TX signal) 252 from baseband processing module 222.

According to one particular embodiment of the present invention, the downlink/uplink interface 308 is operable to receive the outbound data 250 from coupled host processing components, e.g., the host processing component 202 via host interface 220. Further, the downlink/uplink interface 308 is operable to provide inbound data 270 to the coupled host processing components 202 via host interface 220. Baseband processing module 222 may be formed on a single integrated circuit with the other components of radio 204. Further, the radio 204 may be formed in a single integrated circuit along with the host processing components 202. Thus, in such case, all components of FIG. 2 excluding the antenna, display, speakers, et cetera and keyboard, keypad, microphone, et cetera may be formed on a single integrated circuit. However, in still other embodiments, baseband processing module 222 and the host processing components 202 may be formed on a separate integrated circuit. Many differing integrated circuit constructs are possible without departing from the teachings of the present invention.

TX processing components 310 and TX interface 312 couple to the RF front end as illustrated in FIG. 2 and to downlink/uplink interface 308. TX processing components 310 and TX interface 312 are operable to receive the outbound data from downlink/uplink interface 304, to process the outbound data to produce baseband TX signal 252 and to output baseband TX signal 252 to the RF front end as was described with reference to FIG. 2.

RX processing components, including cell searcher module 316, multi-path scanner module 318, chip level processing module 320, and in some cases processor 302, are operable to receive the RX baseband signal 268 from the RF front end as processed by RX I/F 314. Generally, RX I/F 314 produces soft symbols representing the digital reception formatted data 268 in a format suitable for use by these components. HSDPA chip level processing module 320B is operable to produce soft symbols output for use by processing module 322 for further processing, such as turbo coding.

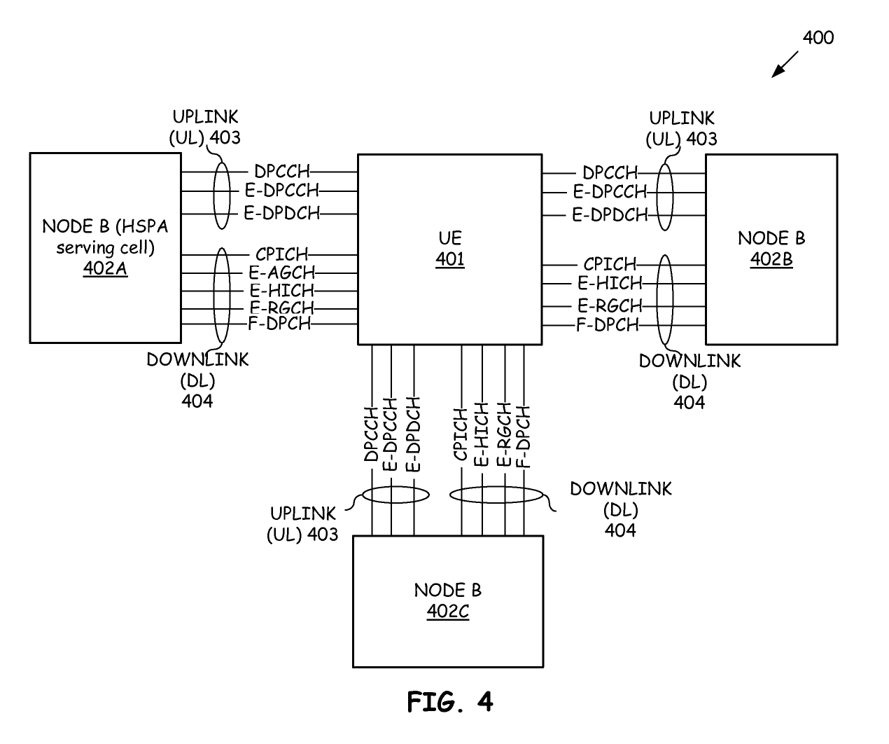

FIG. 4 shows a diagram of a radio link 400 between a User Equipment (UE) 401 and Multiple Node Bs 402A, 402B and 402C. UE 401 may be one of a variety of downlink devices used for wireless communications. UE 401 may be one of the wireless terminals noted in FIG. 1. Multiple Node Bs 402A, 402B and 402C may be one of a variety of uplink devices used for wireless communications. Multiple Node Bs 402A, 402B and 402C may be one of the BS/Node Bs noted in FIG. 1. UE 401 and/or Node B may implement part of or all of the components, modules, devices, circuits noted in FIG. 2 and/or FIG. 3.

UE 401 and Multiple Node Bs 402A, 402B and 402C may communicate using one or more communication protocols or standards, in which communication is achieved by establishing a downlink (DL) and/or uplink (UL) channel(s) for control signal and data transfer, including the use of HSDPA/HSUPA technology. Although various communication standards and protocols may be used, the particular radio link 400 is shown employing a 3GPP standard. In particular, one of the Releases of 3GPP defines a set of dedicated channels. Release 6 of 3GPP, for example, identifies an Enhanced Dedicated Channels (E-DCH). Two uplink E-DCH channels 403 are identified as E-DCH Dedicated Physical Control Channel (E-DPCCH) and E-DCH Dedicated Physical Data Channel (E-DPDCH). Four downlink E-DCH channels 404 are identified as E-DCH Absolute Grant Channel (E-AGCH), E-DCH Relative Grant Channel (E-RGCH), E-DCH Hybrid ARQ Indicator Channel (E-HICH), where ARQ stands for Automatic Repeat-reQuest. Another addition of Release 6 is the Fractional Dedicated Physical Channel (F-DPCH) for HSDPA application.

Uplink DPCCH is used to carry control information generated at Layer 1 and includes known pilot bits to support channel estimation, transmit power control (TPC) commands, feedback information (FBI) and an optional transport-format combination indicator (TFCI). E-DPDCH is used to carry the E-DCH transport channel (e.g. data). There may be zero, one or several uplink DPDCH on each radio link. E-DPCCH carries the Layer 1 control information for E-DPCCH, such as the transport format information.

On the downlink, E-AGCH is used to set the absolute power level limit on E-DPDCH for UE 401 to control the power level. This is done infrequently to set the E-DPDCH transmit power limit of UE 401. For example, a 6-bit command signal may set the initial E-DPDCH transmit power level limit of UE 401. E-AGCH is transmitted from the HSUPA serving cell only. Once the initial power level is set, E-RGCH is used to adjust the E-DPDCH power level limit of UE 401 in incremental levels. For example, a relative grant signal may have three states (+1, 0, −1), in which +1 increases the current power level by one step, −1 decreases the current power level by one step and 0 maintains the current power level. Thus, E-RGCH is used more frequently to adjust the UE power level once the initial power settings are established. E-RGCH can be sent from HSUPA serving cell and non HSUPA serving cell. The difference is HSUPA serving cell can command the increase (i.e., it can transmit 1, 0 and −1) while other cell can not command an increase (i.e., only transmit 0 and −1).

E-HICH is a fixed rate dedicated downlink physical channel carrying the uplink E-DCH Hybrid ARQ acknowledgement indicator. Essentially, E-HICH carries an acknowledgement (ACK) or no acknowledgement (NAK) signal to inform UE 401 if the transmitted information from UE 401 was received or not received by Node B 402. It is to be noted that there is a third state associated with the ACK/NAK signal, which may be a zero state where there is no ACK or NAK sent by Node B 402.

F-DPCH is a fixed rate dedicated downlink physical channel carrying the transmit power control command (TPC) bits for the uplink. There are no other fields occupied in the downlink F-DPCH slot for this user except for the TPC bits. F-DPCH is used on actual data communication happens in the HSDPA channels, and F-DPCH is used for power control purpose only. F-DPCH is subject to power control itself, but unlike legacy WCDMA DPCH channel, F-DPCH quality target is to be maintained for the link to HSDPA serving cell only.

Multiple NodeBs 402A, 402B and 402C communicate to the same UE 401, As shown Multiple Node Bs 402B and 402C do not have E-AGCH, but only the rest of the channels, as E-AGCH is from one Node B (i.e. Node B 402A only). One other channel noted in FIG. 4 is a common downlink channel referred to as a Common Pilot Channel (CPICH), which is a fixed rate physical channel that carries a pre-defined bit sequence. When transmit diversity is used on any downlink channel in a cell, CPICH is transmitted from both antennas using the same channelization and scrambling code. However, the pre-defined bit sequence of the CPICH is different for antenna 1 and antenna 2.

In operation, Node B 402A generally controls the transmitted power limit of E-DPDCH of UE 401 by transferring commands through E-AGCH and E-RGCH. Note E-AGCH can be transmitted from one Node B only, from the HSDPA/HSUPA serving cell. E-HICH is used to convey the ACK/NAK from Node B 402 (all node Bs) to UE 401. F-DPCH is used to control the uplink transmit power. It can be sent from multiple NodeBs to the same UE 401.

A single processing device or a plurality of processing devices operably coupled to memory performs the processing duties. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, cache memory, and/or any device that stores digital information. Note that when the processing duties are implemented via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. The processing duties include the execution of operational instructions corresponding to at least some of the steps and/or functions described above.

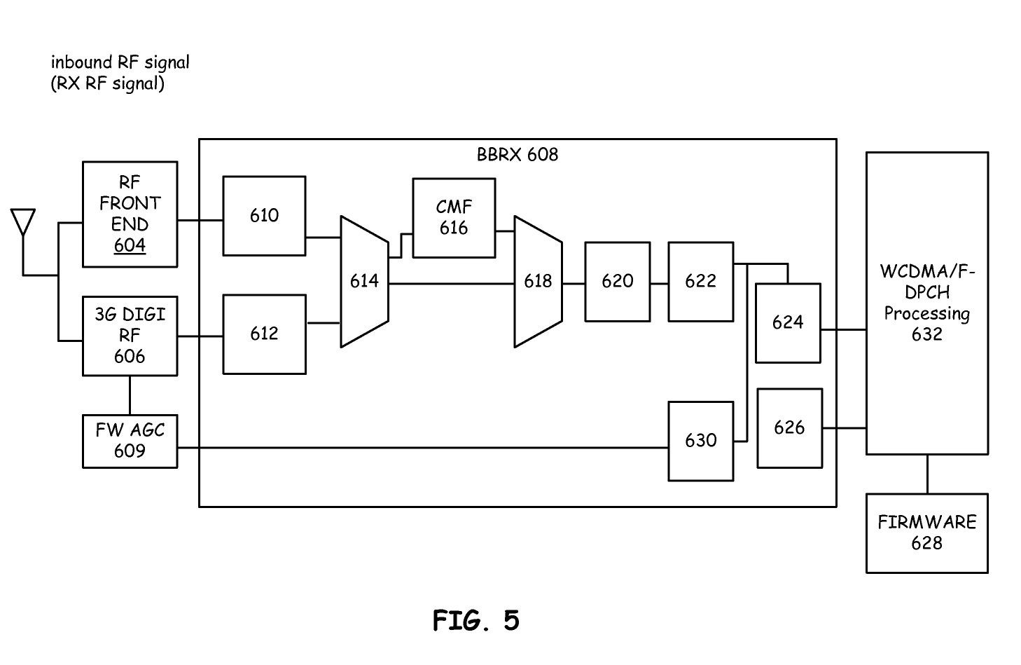

FIG. 5 provides a diagram of a top-level block diagram of a WCDMA receiver in accordance with embodiments of the present invention. F-DPCH processing uses the Rake receiver structure and is implemented as part of the WCDMA receiver within embodiments of the present invention. FIG. 5 specifically shows the data path leading to the WCDMA processing block. The WCDMA block is configured by and later on interacts with the firmware (FW) block to exchange data and control information. In FIG. 5, the receiver uses either the Δ-Σ modulator 604 or the 3G Digi RF block 606 to convert the RF signal 602 to baseband. The output of the Δ-Σ modulator block 604 is a N-level (i.e., N-level I and N-level Q. e.g., N=5) C×M sampled complex signal, while the 3G Digi RF block 606 output is a multi-bit (i.e., 8-bit I and 8-bit Q) C×2(7.68 MHz) sampled complex signal. These signals are the inputs to the baseband processing block (BBRX) block 608 of the WCDMA processor.

Inside BBRX block 608, the input from the Δ-Σ modulator 604 is down-sampled via a reconstruction/decimation FIR filter 610. On the other hand, the output from the 3G Digi RF block 606 may be up-sampled via an interpolation FIR filter 612 to reach the same format. Only one source is used (Δ-Σ modulator block 604 or 3G Digi RF block 606), based on FW configuration. If 3G Digi RF block 606 output is used, then the chip-matched filter (CMF) 616 inside the BBRX can be bypassed if the chip-matched filter inside the 3G Digi RF block 606 is used. The sampled signal is then up-sampled via an interpolation FIR filter 618 to reach a desired signal. A DC-offset detection and correction block 622 then removes the residue DC component from the signal. This signal is down-sampled by decimators 624 and 626 and passed to the WCDMA processing block 632. One signal is used by the searcher while the second is used by the Rake receiver.

The DC-offset sampled data, on a separate path, is down-sampled and then used to measure the RSSI of the received signal to assist the AGC function of the FW block 608 to adjust the variable gain amplifier inside the Analogue front-end blocks 604 or the 3G Digi RF block 606.

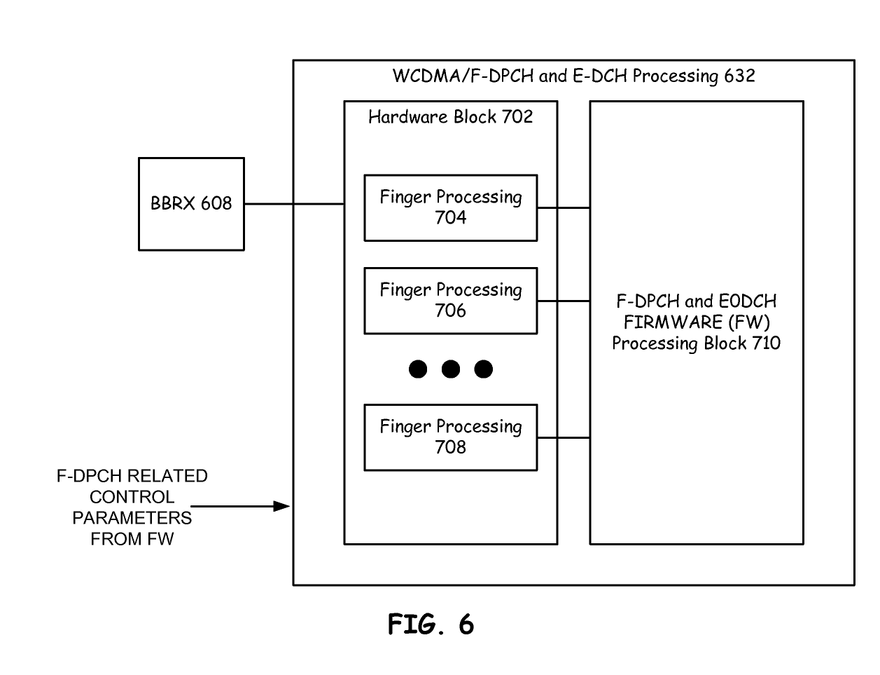

FIG. 6 provides the data/control path between major processing functions inside the F-DPCH and E-DCH (including E-AGCH, E-HICH and E-RGCH) processing block (WCDMA processing block 632) in accordance with embodiments of the present invention. FIG. 6 shows the data/control path between major processing functions inside the F-DPCH and E-DCH processing block in accordance with embodiments of the present invention. As shown here, BBRX 608 provides an output to WCDMA processing block 632 comprising hardware block 702 that contains multiple finger processing blocks 704, 706 and 708 wherein soft symbols for the individual fingers are produced and provided to FW processing block 710. The hardware blocks for F-DPCH and E-DCH reuse the Rake receiver structure that for the processing for DPCCH when DPCH is configured, with modifications. FW processing block needs to be modified as well.

FW block 710 is in charge of setting up the Rake fingers. In legacy WCDMA operations, FW examines all the received signals from the cells in the active set and allocates the strongest N fingers to the Rake receiver, N is chosen to make the compromise between complexity and performance. For legacy WCDMA applications, N ranges from 6 to 12. In 3GPP, a minimum active set size is specified to be 6. So when 6 cells are in the active set, and it N=6, each cell can get one finger if signal from it is strong when arriving at the UE. However, there maybe cases where all 6 fingers go to a single cell.

For legacy WCDMA channels, all cells in the active set transmit the same DPCH data to the UE, so allocating Rake fingers to the strongest N paths, regardless which cell they are from is the right strategy. For HSDPA and HSUPA applications, they are no longer the best strategy.

For F-DPCH, the quality is to be maintained on the link to HSDPA serving cell, therefore, finger assignment to paths discovered for the link to HSDPA serving cell takes priority. This also ensures good reception of the E-AGCH channel, as HSDPA and HSUPA has the same serving cell.

For E-DCH application, cells other than HSUPA serving cell can instruct the UE to have a lower E-DPDCH transmit power limit, this is to ensure the UE does not create too much interference. So when FW assign fingers, it assigns at least one finger to any one cell in the E-DCH active set. The E-DCH active set is a subset of the legacy DCH active set.

Therefore the finger assignment strategy will be dependent on the application scenarios.

In the scenario where only legacy WCDMA communication is used, the finger assignment strategy is the legacy one as well, i.e., allocate the fingers to the strongest paths, regardless which cell they are from.

In the scenario where HSDPA is added on top of the legacy WCDMA, the finger assignment strategy is the legacy one. But if there are fingers left after running the legacy finger assignment procedure, the left over fingers should go to those paths from the HSDPA serving cell. To make this more sophisticated, a weighting function can be applied to the path from the HSDPA serving cell so that they can be assigned a finger as long as they are no larger than X dB smaller than the paths from other cells.

In the scenario where HSDPA is used with F-DPCH, the finger assignment strategy is paths from the serving cell have the priority. As this is the link whose quality has to be maintained. Left over fingers can be assigned to other paths from other cells than the serving HSDPA cell.

In the scenario where HSUPA is used, every cell in the E-DCH active set should have at least one fingers assigned to it. Left over fingers goes to the HSUPA serving cell. This may be in conflict with the F-DPCH in HSDPA. In this case the hardware may have to consider increasing the number of fingers.

In summary, embodiments of the present invention provide a downlink channel receiver operable to implement finger management strategies with fractional dedicated physical channel (F-DPCH) processing and E-DCH processing within a Rake receiver structure. The downlink channel receiver includes a receiver, a baseband processing block, and a WCDMA processing block, wherein F-DPCH and E-DCH processing is divided between a plurality of hardware processing blocks and a plurality of firmware (FW) processing blocks. The finger management strategies within the Rake receiver structure are implemented by the plurality of FW processing blocks.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The foregoing description of a preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A method to implement finger management strategies with Firmware Processing Blocks within wireless User Equipment (UE) having a Rake receiver structure, comprising:
receiving a processed baseband signal at a WCDMA processing block, wherein F-DPCH processing is divided between a plurality of hardware processing blocks and a plurality of firmware (FW) processing blocks, wherein:
the plurality of hardware blocks comprise a plurality of finger processing blocks operable to produce a set of soft symbols for each finger; and
the plurality of FW processing blocks process the set of soft symbols wherein the finger management strategy is based on an application scenario, wherein the application scenarios comprise:
only legacy WCDMA communications;
HSDPA communications in addition to the legacy WCDMA communications;
HSDPA communications with F-DPCH; and
HSUPA communications.

2. The method of claim 1, the finger management strategy based on the only legacy WCDMA communications comprises allocate fingers assignments to strongest paths, regardless of which cell a received signal is from.

3. The method of claim 1, the finger management strategy based on the HSDPA communications in addition to the legacy WCDMA communications comprises:
allocate fingers assignments to strongest paths, regardless of which cell a received signal is from; and
allocate fingers assignments of any remaining fingers to those paths from a HSDPA serving cell.

4. The method of claim 3, wherein a weighting function is applied to paths from the HSDPA serving cell so that assignments of any remaining fingers to those paths from the HSDPA serving cell occur only when those paths from the HSDPA serving cell are no larger than X dB smaller than paths from other cells.

5. The method of claim 1, wherein the finger management strategy based on the HSDPA communications with F-DPCH comprises:
allocate fingers assignments to the HSDPA serving cell have priority; and
allocate fingers assignments of any remaining fingers to those paths from other cells.

6. The method of claim 1, wherein the finger management strategy based on the HSUPA communications comprises:
allocate at least one finger assignment to each cell in an E-DCH active set; and
allocate fingers assignments of any remaining fingers to the HSDPA serving cell have priority.

7. The method of claim 1, wherein the finger management strategies comprise:
finger assignment according to DPCH within a single radio link scenario;
finger assignment bias towards a serving HS-DSCH cell within a single radio link set (RLS) scenario; and
finger assignment bias toward a RLS containing the serving HS-DSCH cell within a multiple RLS scenario.

8. The method of claim 7, wherein finger assignment bias toward a RLS containing the serving HS-DSCH cell within a multiple RLS scenario further comprises finger assignment bias toward the serving HS-DSCH cell within the RLS containing the serving HS-DSCH cell.

9. The method of claim 1, wherein the plurality of FW processing blocks comprise a finger management processing module operable to implement the finger management startegies.

10. The method of claim 1, wherein the baseband signal is produced by a receiver and baseband processing block, wherein the receiver comprises a RF front end and/or a 3G Digi RF.

11. User Equipment operable to implement a finger management strategy selected from multiple finger management strategies, comprising:
a rake receiver structure operable to convert radio frequency (RF) signal(s) to a baseband signal(s);
a baseband processing block operable to provide processed baseband signal(s); and
a WCDMA processing block, operable to receive the processed baseband signal(s), wherein processing is divided between:
a plurality of hardware processing blocks; and
a plurality of firmware (FW) processing blocks, wherein the finger management strategies within the Rake receiver structure are implemented by the plurality of firmware (FW) processing blocks; wherein the implemented finger management strategy is based on an application scenario, wherein the application scenarios comprise:
only legacy WCDMA communications;
HSDPA communications in addition to the legacy WCDMA communications;
HSDPA communications with F-DPCH; and
HSUPA communications.

12. The User Equipment of claim 11, the finger management strategy based on the only legacy WCDMA communications comprises allocate fingers assignments to strongest paths, regardless of which cell a received signal is from.

13. The User Equipment of claim 11, the finger management strategy based on the HSDPA communications in addition to the legacy WCDMA communications comprises:
allocate fingers assignments to strongest paths, regardless of which cell a received signal is from; and
allocate fingers assignments of any remaining fingers to those paths from a HSDPA serving cell.

14. The method of claim 3, wherein a weighting function is applied to paths from the HSDPA serving cell so that assignments of any remaining fingers to those paths from the HSDPA serving cell occur only when those paths from the HSDPA serving cell are no larger than X dB smaller than paths from other cells.

15. The User Equipment of claim 11, wherein the finger management strategy based on the HSDPA communications with F-DPCH comprises:
allocate fingers assignments to the HSDPA serving cell have priority; and
allocate fingers assignments of any remaining fingers to those paths from other cells.

16. The User Equipment of claim 11, wherein the finger management strategy based on the HSUPA communications comprises:
allocate at least one finger assignment to each cell in an E-DCH active set; and
allocate fingers assignments of any remaining fingers to the HSDPA serving cell have priority.

17. The User Equipment of claim 11, wherein the finger management strategies comprise:
finger assignment according to DPCH within a single radio link scenario;
finger assignment bias towards a serving HS-DSCH cell within a single radio link set (RLS) scenario; and
finger assignment bias toward a RLS containing the serving HS-DSCH cell within a multiple RLS scenario.

18. The method of claim 7, wherein finger assignment bias toward a RLS containing the serving HS-DSCH cell within a multiple RLS scenario further comprises finger assignment bias toward the serving HS-DSCH cell within the RLS containing the serving HS-DSCH cell.

19. The User Equipment of claim 11, wherein the plurality of FW processing blocks comprise a finger management processing module operable to implement the finger management strategies.

20. The User Equipment of claim 11, wherein the baseband signal is produced by a receiver and baseband processing block, wherein the receiver comprises a RF front end and/or a 3G Digi RF.
